(19) United States
(12) Patent Application Publication
(10) Pub. No.: US 2015/0161030 A1
(43) Pub. Date: Jun. 11, 2015

(54) DETECTING METHOD AND SYSTEM FOR CONCURRENCY BUGS

(71) Applicant: Tsinghua University, Beijing (CN)

(72) Inventors: Yongwei WU, Beijing (CN); Kang CHEN, Beijing (CN); Weimin ZHENG, Beijing (CN); Mingxing ZHANG, Beijing (CN)

(21) Appl. No.: 14/562,706

(22) Filed: Dec. 6, 2014

(30) Foreign Application Priority Data
Dec. 6, 2013 (CN) 201310659010.1

(51) Int. Cl. G06F 11/36; G06F 9/44

(52) U.S. Cl. CPC G06F 11/3688; G06F 8/70

(57) ABSTRACT

In a detecting method for concurrency bugs, a Current Fetter Set is defined for a dynamic instance of a static instruction in program invariants. A Belonging Invariants Set and an Enforcing Invariants Set from the Current Fetter Set are extracted. The Belonging Invariants Set and the Enforcing Invariants Set are pruned to obtain final results after pruning and storing the final results after pruning in an invariants database. Invariant violation is detected using a detection unit whether a first Current Fetter Set dissatisfying with corresponding Belonging Invariants Set and Enforcing Invariants Set is shown. If yes, the first Current Fetter Set is determined to contain a bug, the detection unit generating a violation report. A currently-running thread (the violated thread) is stalled to prevent running of the bug.

### CROSS-REFERENCE TO RELATED APPLICATION

This application claims priority to and benefits of Chinese Patent Application Serial No. 201310659010.1, filed with the State Intellectual Property Office of P. R. China on Dec. 06, 2013, the entire contents of which are incorporated herein by reference.

### FIELD

The present disclosure relates to program engineering technologies, and more particularly to a detecting method and system for concurrency bugs.

### BACKGROUND

Generally speaking, research on data race is known as two major parts: lock-set approach (such as Eraser) and happened-before approach (such as SigRace). Although sufficient research has been made on the data race, it is not enough even all data race are solved perfectly. The reasons are that: 1) most of the data race do not cause substantial consequences, i.e., they are benign; 2) There exists atomicity violation that is not contained in data race; 3) most of order-violation bugs cannot be simply solved by packing them into a critical section.

Because of limitation of a tool for singly detecting data race, the research on how to solve the atomicity-violation bugs has become a hot topic and has become focus of many research works. In contrast, there are few researches on the order-violation bugs, and in these few researches, they can only handle a sub-set of the order-violation bugs defined by themselves basically. For example, although Con-NULL of ConMem and Local/Remote (LR) Invariants of DefUse handle their own part, “write-write” order-violation bugs cannot be well handled.

Additionally, the bug prevention is a complementary method to the bug detection. There are problems existing in this method: 1) although many testes have been made, it cannot ensure that all bugs have been found; 2) a misunderstanding of a bug that has been reported may introduce a new bug caused by a fixing patch; 3) a time interval between the bug being found and the bug being fixed is too long. Although there are many improvement methods, such as PSet, LifeTxes, Pacman, Rcdc and Bulksc, they need support of complex hardware and most of them cannot handle the order-violation bug.

There are many relevant methods which have been provided on a relatively-mature technology of execution codes having a large amount of blocks as units, such as transaction memory. These methods or hardware are used to reduce uncertainty of multi-thread programs, thereby reducing the discovery probability and the debugging difficulty of a bug. However, although a new programming model is used, the occurrence of bug has not been prevented. More important, in two instructions which constitute a order violation, that one instruction is closer to a bifurcation point in a block-based execution way than anther instruction does not exist, therefore, the block-based execution way increases the occurrence probability of order-violation bug instead.

### SUMMARY

In our implementation, a detecting method for concurrency bugs, includes following steps: defining a Current Fetter Set for a dynamic instance of a static instruction in program invariants, wherein the program invariants are instruction sets which are executed according to a preset order in a program; extracting a Belonging Invariants Set and an Enforcing Invariants Set from the Current Fetter Set; pruning the Belonging Invariants Set and the Enforcing Invariants Set to obtain final results after pruning and storing the final results after pruning in an invariants database; detecting invariant violation using a detection unit whether a first Current Fetter Set dissatisfying with corresponding Belonging Invariants Set and Enforcing Invariants Set is shown, if yes, determining that the first Current Fetter Set contains a bug, the detection unit generating a violation report; and stalling a currently-running thread to prevent running of the bug.

The detecting method for concurrency bugs can automatically detect and prevent potential concurrency bugs in program. No developer's manual annotation is needed and this method can be widely used.

According to an embodiment of the present disclosure, the Current Fetter Set is that: in instructions executed before the instruction, a set of instructions which are executed immediately before the instruction and operate the same memory as the instruction operates.

According to an embodiment of the present disclosure, the Belonging Invariants Set is a union of the Current Fetter Sets of all dynamic instances of the instruction; the Enforcing Invariants Set is an intersection of the Current Fetter Sets of all dynamic instances of the instruction.

According to an embodiment of the present disclosure, in the steps of stalling a currently-running thread to prevent running of the bug, when a stalling time reaches a preset time threshold or number of the stalling reaches a preset number threshold, resuming running of the thread.

According to an embodiment of the present disclosure, the method further includes: transferring a Trigger Set from the Enforcing Invariants Set, which is used to detect whether Trigger Set violation exists, wherein the Trigger Set is the inversion of the Enforcing Invariants Set.

In our implementation, a detecting system for concurrency bugs, includes: an extracting module configured to extract a Belonging Invariants Set and an Enforcing Invariants Set from a Current Fetter Set and to continuously update the Belonging Invariants Set and the Enforcing Invariants Set; a pruning module configured to remove low-confidence parts in the Belonging Invariants Set and the Enforcing Invariants Set to obtain final results after pruning; a detecting module configured to detect invariant violation using a detection unit whether a first Current Fetter Set dissatisfying with corresponding Belonging Invariants Set and Enforcing Invariants Set is shown, if yes, to determine that the first Current Fetter Set contains a bug, the detection unit generating a violation report; a preventing module configured to stall a currently-running thread to prevent running of the bug; an exposing module configured to expose hidden bugs in a multi-thread running instruction.

The detecting system for concurrency bugs can automatically detect and prevent potential concurrency bugs in program. No developer's manual annotation is needed and this method can be widely used.

According to an embodiment of the present disclosure, the Current Fetter Set is that: in instructions executed before the instruction, a set of instructions which are executed immediately before the instruction and operate the same memory as the instruction operates.

According to an embodiment of the present disclosure, the Belonging Invariants Set from the Current Fetter Set is a union of the Current Fetter Sets of all dynamic instances of the instruction; the Enforcing Invariants Set from the Current Fetter Set is an intersection of the Current Fetter Sets of all dynamic instances of the instruction.

According to an embodiment of the present disclosure, the preventing module is further configured to, when a stalling time reaches a preset time threshold or number of stalling reaches a preset number threshold, resume running of the thread.

According to an embodiment of the present disclosure, the exposing module is further configured to transfer a Trigger Set from the Enforcing Invariants Set, which is used to detect whether Trigger Set Violation exists, and the Trigger Set is the inversion of the Enforcing Invariants Set.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions taken in conjunction with the drawings in which:

FIG. 1 is a flow chart of a detecting method for concurrency bugs, according to an embodiment of the present disclosure;

FIG. 2 is a schematic view showing a specific operating process, according to an embodiment of the present disclosure; and

FIG. 3 is a block diagram of a detecting system for concurrency bugs, according to an embodiment of the present disclosure.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

A detecting method for concurrency bugs, according to an embodiment of the present disclosure, includes following steps:

defining a Current Fetter Set for a dynamic instance of a static instruction in program invariants;

extracting a Belonging Invariants Set and an Enforcing Invariants Set from the Current Fetter Set;

pruning the Belonging Invariants Set and the Enforcing Invariants Set to obtain final results after pruning and storing the final results after pruning in an invariants database;

detecting invariant violation using a detection unit whether a first Current Fetter Set dissatisfying with corresponding Belonging Invariants Set and Enforcing Invariants Set is shown, if yes, determining that the first Current Fetter Set contains a bug, the detection unit generating a violation report;

stalling a currently-running thread to prevent running of the bug.

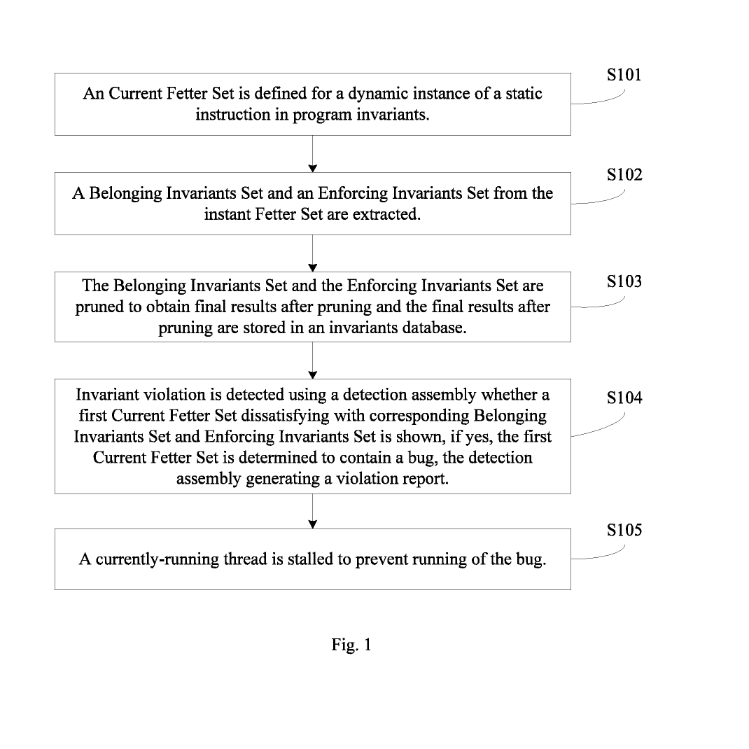

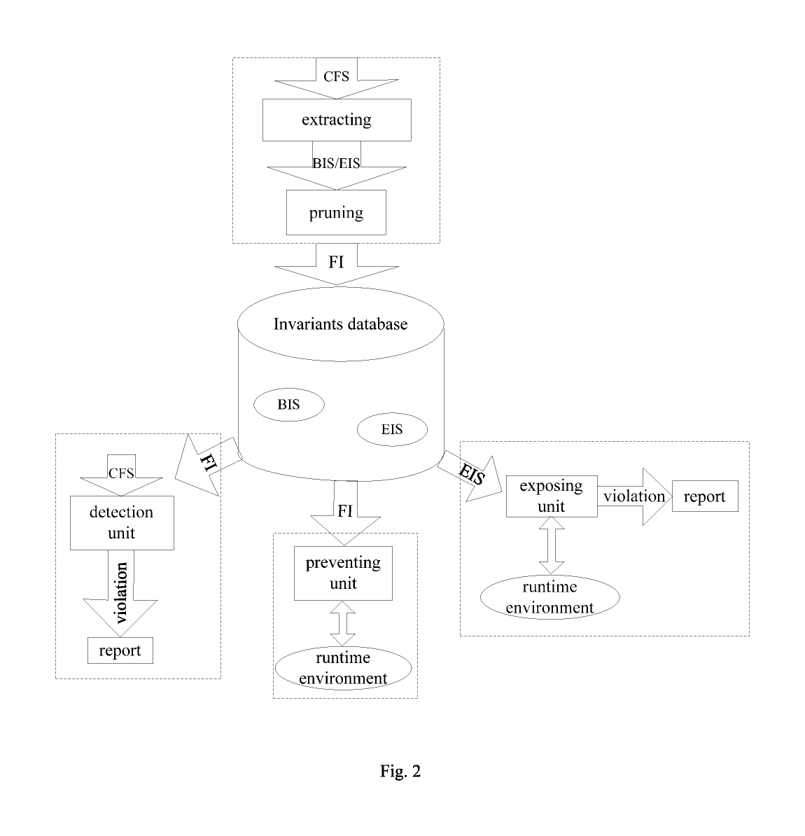

FIG. 1 is a flow chart of a detecting method for concurrency bugs, according to an embodiment of the present disclosure. FIG. 2 is a schematic view showing a specific operating process, according to an embodiment of the present disclosure.

Referring to FIG. 1 and FIG. 2, an implementation process of the detecting method for the concurrency bugs is as follows:

Step S101: a Current Fetter Set is defined for a dynamic instance of a static instruction in program invariants, wherein the program invariants are instruction sets which are executed according to a preset order in a program.

Specifically, a Current Fetter Set (CFS) is defined for a dynamic instance of a static instruction I in program invariants, i.e., CFS(I). CFS (I) is an instruction set in math, and consists of instructions which are executed immediately before I and operate the same memory as I operates in all instructions executed before I. If number of this instruction is zero, then it is labeled as NULL. For example, an instruction I1 in a thread 1 is called as immediately executed before an instruction I2 in a thread 2 if and only if there is no running instruction operating the same memory in the thread 1 between executions of I1 and I2.

Step S102: a Belonging Invariants Set and an Enforcing Invariants Set from the Current Fetter Set are extracted.

Specifically, a Belonging Invariants Set of one instruction I, i.e., BIS(I), is an instruction set, describing whether this instruction can be contained in CFS of another instruction. Its value is equal to a union of CFS of all dynamic instances of this instruction. If all instructions can belong to CFS of I, BIS(I) is labeled as ALL.

An Enforcing Invariants Set of one instruction I, i.e., EIS(I), is used to describe whether this instruction must be contained in CFS of another instruction. It means an intersection of CFS of all dynamic instances of this instruction.

In the actual operation, in order to automatically obtain FI (Fetter Invariants) without conditions of any human's label intervention, i.e., sum of the Belonging Invariants Set BIS and the Enforcing Invariants Set EIS of the Current Fitter Set needs a certain amount of correctly-running dynamic instances. For a multi-thread program, because the running uncertainty of multi-thread program, even for multi-time running of the same input data, it can be considered to be different running dynamic instances. Therefore, it is easier to obtain a large amount of running dynamic instances. Commonly-used system testing tools, such as CHESS and CTrigger, can be used to expose the running dynamic instances as comprehensive as possible.

In practice, order relationships between instructions can be obtained by execution of a tracking program. Specifically, during running of the program, an extraction unit can record a last-executed instruction for each group <thread ID, memory address>. This thread can update this record for each operation to this memory. CFS(I) corresponding to the dynamic instance of the instruction I can be obtained dynamically through these records. After extracting CFS(I), operations are as follows:

(1) FI, i.e., BIS(I) and EIS(I), is initialized.

Specifically, BIS(I) and EIS(I) are initialized as Ø and ALL respectively.

(2) FI is updated as follows:

BIS(I)→BIS(I)∪CFS(I)

EIS(I)→EIS(I)∩CFS(I)

Where, BIS(I) and EIS(I) at right side of the formula are FI extracted before execution of a current dynamic instance of the instruction I.

(3) FI which each instruction I learns is stored to be pruned after the above learning and training.

Specially, in practical execution process, recorder variant still needs to be maintained dynamically to record the current operation of the memory.

Step S103: the Belonging Invariants Set and the Enforcing Invariants Set are pruned to obtain final results after pruning and the final results after pruning are stored in an invariants database;

Because of the complexity of multi-thread program, the test at the training stage might be insufficient. That is to say, tested interleavings might not cover all possible run paths.

Therefore, in order to solve problems which the insufficient training possibly brings, after execution of the program in the step S102, the extraction unit is responsible for the pruning operation to remove low-confidence parts of FI and remaining parts are final results after pruning. The final results after pruning are stored in the invariants database, waiting to be operated.

Specifically, the implementation process of pruning is as follows:

(1) Low-appearance-probability program invariants are pruned.

Generally, number of the correctly-running dynamic instance which is used to learn and train is at least 10. Therefore, it can be considered that it is very low possibility that confidence of invariant is shown once in all training instances. Therefore, these invariants are removed from EIS. Similarly, if confidence of considerable-proportion invariants in BIS is not high, BIS of this instruction is labeled as ALL. As mentioned before, ALL indicates that all instructions belong to CFS of this instruction. If EIS is NULL and BIS is ALL in FI corresponding to one instruction, this one instruction can be omitted to save memory space.

Specifically, pairs of EIS and BIS need to be accessed successively. Using one map data structure counts these pairs of EIS and BIS. Then this map is searched to label pair of EIS and

BIS which is shown once as insufficient pair and remove this pair from EIS. Finally, all BIS are checked, and proportion of insufficient pair of instructions is calculated. If this proportion is higher than a preset threshold, BIS is labeled as ALL.

(2) Too-popular instructions are pruned.

The instructions in often-called small functions have a large number of BIS. At this time, these BIS are labeled as ALL.

Similarly, there are instructions in Dynamic Link Library. The number of their PC will change when loading conditions change, thereby extracting very great-value BIS. At this time, it needs to check all BIS, and calculate their values. If the value is greater than a preset threshold (generally set to 5), BIS is labeled as ALL.

(3) Instructions which do not access the sharing variants are pruned.

Because the method according an embodiment of the present disclosure processes concurrency bugs, so the instructions which do not access the sharing variants will be removed. Specifically, the instructions which do not access the sharing variables can be obtained from recorder variant of dynamic maintenance in execution of the program. These instructions are deleted from EIS and BIS.

The FI after pruned is stored in the invariants database.

Step S104: invariant violation is detected using a detection unit whether a first Current Fetter Set dissatisfying with corresponding Belonging Invariants Set and Enforcing Invariants Set is shown, if yes, the first Current Fetter Set is determined to contain a bug, the detection unit generating a violation report.

The specific implementation process is as follows:

(1) FI, i.e., BIS and EIS, is read from the invariants database, and FI is initialized.

(2) a detection unit dynamically calculates CFS(I) of the dynamic instance of each instruction I by maintaining a specific domain and compares with the corresponding FI. For each instruction, if feature of the running dynamic instance not meeting the corresponding FI is monitored, then violation is determined. The detection unit generates a violation report and sends it to the developer for further analysis. Violation means that during the running, the condition does not meet the following formula: EIS(I)⊂CFS(I)⊂BIS(I)

Specially, in order to save memory and time, this operation is executed for instructions which access the sharing variant.

Additionally, the detection stage is also used to further remove insufficient invariants. After analyzing, the reason of causing violation is not that violation part of the bug can be deleted from FI. That is to say, after the developer makes decision of the current violation being not a bug according to analysis of the program and the report, the instruction is deleted from the invariants database by executing a method similar to the method for pruning low-appearance-probability program invariants in step S103. In this way, when the same instruction alternating is shown again, the violation report about a suspected bug will not be generated.

Step S105: a currently-running thread is stalled to prevent running of the bug.

On the basis of violation detected in step S104, the running of bug is prevented by directly stalling the currently-running thread. The currently-running thread is the violated thread. Specially, in order to prevent the running of bug, the detection step of violation is executed before the actual execution of the instruction.

Specifically, potential bugs can be detected before the actual exposure of the bugs by the alternating running of instructions between threads which pass the test. The running of bug is prevented by stalling the current thread until running of other threads solve the violation. In the stalling process of the current thread, if other threads operate the same memory, CFS of the current thread is calculated again and detected again. Running of the thread is resumed if success. During running of the program, recorder variant still needs to be maintained dynamically to record the current access of the memory.

It is noted that not all of FI violations can be solved by stalling. Because learning and training might be not enough, the only appropriate instruction alternating might not appear in the learning and training stage of FI, therefore, it cannot be learned. In order to ensure the program does not have an infinite deadlock, a reasonable threshold value needs to be set according to specific situation of the program. When stalling time reaches a preset time threshold or number of stalling reaches a preset number threshold, running of the thread is resumed and a report about this violation being unsolvable is sent to the developer. After the developer's analysis, if the reason of causing this situation is not the bug, the restriction can be loosened by patching FI and this instruction alternating is allowed to be executed in the future. The patching method is similar to the method for pruning low-appearance-probability program invariants in step S103.

Preferably, during the actual running of the program, step S105 can be an independent prevention way on the basis of the detection of violation in step S104 and solves the violation by directly stalling the current thread, thereby preventing the running of bug. No violation report needs to be sent to the developer.

Further, in an embodiment of the present disclosure, a method for detecting and exposing a multi-thread bug in a normal operation environment is provided. That is to say, a Trigger Set is transferred from the Enforcing Invariants Set, which is used to detect whether Trigger Set violation exists. The Trigger Set is the inversion of the Enforcing Invariants Set.

In the actual operation, it is not realistic to detect those rarely-appearing bugs simply by the above steps. In an embodiment of the present disclosure, according to the definition of FI, if instruction I1 belongs to EIS of instruction I2, it indicates that I1 is executed before I2 in all correctly-running dynamic instances. Otherwise, there might be a hidden bug.

In order to detect potential bugs, implementation steps of a method for exposing the potential bugs in an embodiment of the present disclosure include:

(1) a Trigger Set (TS(I)) is defined for each of instructions I correspondingly.

In math, TS is the inversion of EIS, i.e., I1 belongs to TS of I2 if and only if I2 belongs to EIS of I1.

(2) EIS is read from the invariants database and is initialized.

(3) After dynamically calculating CSF(I) of each instruction I, whether a condition meets the following formula is determined: TS(I) c EIS(I)

If TS(I)/⊂EIS(I) then the current thread is stalled. This rule will be continuously checked until conditions are meet or reach corresponding threshold (this threshold should be set longer than that in step S105).

Because TS is a reflection of EIS, a preset execution order of instructions inherent in EIS will cause violation on TS in the correct instruction alternating. Therefore, the current thread is stalled by an preventing unit to increase flipping probability of running order of two instructions. But, if the order is guaranteed by semaphore or something else, the violation will be maintained until it reaches the threshold.

The detecting method for concurrency bugs can automatically detect and prevent potential concurrency bugs in program. No developer's manual annotation is needed and this method can be widely used.

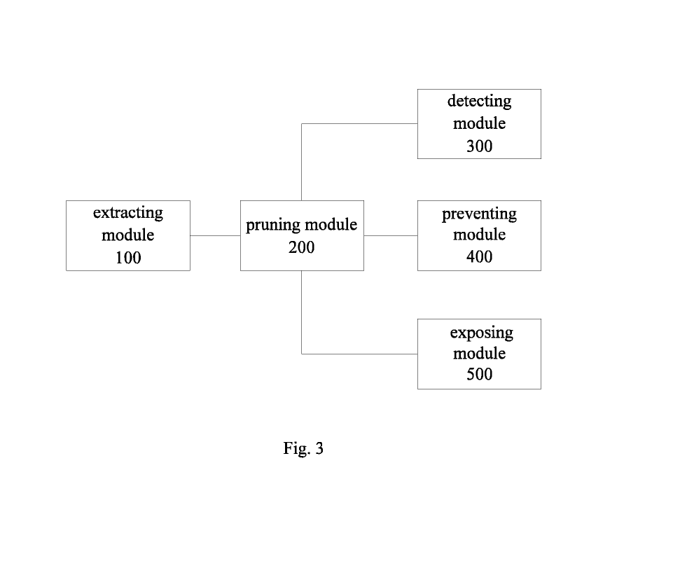

A detecting system for concurrency bugs, according to another embodiment of the present disclosure, as shown in FIG. 3, includes an extracting module 100, a pruning module 200, a detecting module 300, a preventing module 400 and an exposing module 500.

The extracting module 100 is configured to obtain a Belonging Invariants Set and an Enforcing Invariants Set from a Current Fetter Set. The pruning module 200 is configured to remove low-confidence parts in the Belonging Invariants Set and the Enforcing Invariants Set to obtain final results after pruning. The detecting module 300 is configured to detect invariant violation using a detection unit whether a first Current Fetter Set dissatisfying with corresponding Belonging Invariants Set and Enforcing Invariants Set is shown, if yes, to determine that the first Current Fetter Set contains a bug, the detection unit generating a violation report. The preventing module 400 is configured to stall a currently-running thread to prevent running of the bug. The exposing module 500 is configured to expose hidden bugs in a multi-thread running instruction.

Specifically, firstly, the Current Fetter Set is defined for a dynamic instance of a static instruction I in program invariants, i.e., CFS(I). The program invariants are instruction sets which are executed according to a preset order in a program. CFS (I) is an instruction set in math, and consists of instructions which are executed immediately before I and operate the same memory as I operates in all instructions executed before I. If number of this instruction is zero, then it is labeled as NULL. For example, an instruction I1 in a thread 1 is called as immediately executed before an instruction I2 in a thread 2 if and only if there is no running instruction operating the same memory in the thread 1 between executions of I1 and I2.

In the extracting module 100, a Belonging Invariants Set and an Enforcing Invariants Set from the Current Fetter Set are extracted. Specifically, a Belonging Invariants Set of one instruction I, i.e., BIS(I), is an instruction set, describing whether this instruction can be contained in CFS of another instruction. Its value is equal to a union of CFS of all dynamic instances of this instruction. If all instructions can belong to CFS of I, BIS(I) is labeled as ALL.

An Enforcing Invariants Set of one instruction I, i.e., EIS(I), is used to describe whether this instruction must be contained in CFS of another instruction. It means an intersection of CFS of all dynamic instances of this instruction.

In the actual operation, in order to automatically obtain FI (Fetter Invariants) without conditions of any human's label intervention, i.e., sum of the Belonging Invariants Set BIS and the Enforcing Invariants Set EIS of the Current Fitter Set needs a certain amount of correctly-running dynamic instances. For a multi-thread program, because the running uncertainty of multi-thread program, even for multi-time running of the same input data, it can be considered to be different running dynamic instances. Therefore, it is easier to obtain a large amount of running dynamic instances. Commonly-used system testing tools, such as CHESS and CTrigger, can be used to expose the running dynamic instances as comprehensive as possible.

In practice, order relationships between instructions can be obtained by execution of a tracking program. Specifically, during running of the program, an extraction unit can record a last-executed instruction for each group <thread ID, memory address>. This thread can update this record for each operation to this memory. CFS(I) corresponding to the dynamic instance of the instruction I can be obtained dynamically through these records. After extracting CFS(I), operations are as follows:

(1) FI, i.e., BIS(I) and EIS(I), is initialized.

Specifically, BIS(I) and EIS(I) are initialized as Ø and ALL respectively.

(2) FI is updated as follows:

BIS(I)→BIS(I)∪CFS(I)

EIS(I)→EIS(I)∩CFS(I)

Where, BIS(I) and EIS(I) at right side of the formula are FI extracted before execution of a current dynamic instance of the instruction I.

(3) FI which each instruction I learns is stored to be pruned after the above learning and training.

Specially, in practical execution process, recorder variant still needs to be maintained dynamically to record the current operation of the memory.

In the pruning module 200, because of the complexity of multi-thread program, the test at the training stage might be insufficient. That is to say, tested interleavings might not cover all possible run paths. Therefore, in order to solve problems which the insufficient training possibly brings, after the execution of the program is finished in the extracting module 100, the extraction unit is responsible for the pruning operation to remove low-confidence parts of FI and remaining parts are final results after pruning. The final results after pruning are stored in the invariants database, waiting to be operated.

Specifically, the implementation process of pruning is as follows:

(1) Low-appearance-probability program invariants are pruned.

Generally, number of the correctly-running dynamic instance which is used to learn and train is at least 10. Therefore, it can be considered that it is very low possibility that confidence of invariant is shown once in all training instances. Therefore, these invariants are removed from EIS. Similarly, if confidence of considerable-proportion invariants in BIS is not high, BIS of this instruction is labeled as ALL. As mentioned before, ALL indicates that all instructions belong to CFS of this instruction. If EIS is NULL and BIS is ALL in FI corresponding to one instruction, this one instruction can be omitted to save memory space.

Specifically, pairs of EIS and BIS need to be accessed successively. Using one map data structure counts these pairs of EIS and BIS. Then this map is searched to label pair of EIS and BIS which is shown once as insufficient pair and remove this pair from EIS. Finally, all BIS are checked, and proportion of insufficient pair of instructions is calculated. If this proportion is higher than a preset threshold, BIS is labeled as ALL.

(2) Too-popular instructions are pruned.

The instructions in often-called small functions have a large number of BIS. At this time, these BIS are labeled as ALL.

Similarly, there are instructions in Dynamic Link Library. The number of their PC will change when loading conditions change, thereby extracting very great-value BIS. At this time, it needs to check all BIS, and calculate their values. If the value is greater than a preset threshold (generally set to 5), BIS is labeled as ALL.

(3) Instructions which do not access the sharing variants are pruned.

Because the method according an embodiment of the present disclosure processes concurrency bugs, so the instructions which do not access the sharing variants will be removed. Specifically, the instructions which do not access the sharing variables can be obtained from recorder variant of dynamic maintenance in execution of the program. These instructions are deleted from EIS and BIS.

The FI after pruned is stored in the invariants database.

In the detecting module 300, invariant violation is detected using a detection unit whether a first Current Fetter Set dissatisfying with corresponding Belonging Invariants Set and Enforcing Invariants Set is shown, if yes, the first Current Fetter Set is determined to contain a bug, the detection unit generating a violation report.

The specific implementation process is as follows:

(1) FI, i.e., BIS and EIS, is read from the invariants database, and FI is initialized.

(2) a detection unit dynamically calculates CFS(I) of the dynamic instance of each instruction I by maintaining a specific domain and compares with the corresponding FI. For each instruction, if feature of the running dynamic instance not meeting the corresponding FI is monitored, then violation is determined. The detection unit generates a violation report and sends it to the developer for further analysis. Violation means that during the running, the condition does not meet the following formula: EIS(I)⊂CFS(I)⊂BIS(I)

Specially, in order to save memory and time, this operation is executed for instructions which access the sharing variant. Additionally, the detection module 300 is also configured to further remove insufficient invariants. After analyzing, the reason of causing violation is not that violation part of the bug can be deleted from FI. That is to say, after the developer makes decision of the current violation being not a bug according to analysis of the program and the report, the instruction is deleted from the invariants database by executing a method similar to the method for pruning low-appearance-probability program invariants in the pruning module 200. In this way, when the same instruction alternating is shown again, the violation report about a suspected bug will not be generated.

The preventing module 400 is configured to stall a currently-running thread to prevent running of the bug. The currently-running thread is the violated thread. Specifically, potential bugs can be detected before the actual exposure of the bugs by the alternating running of instructions between threads which pass the test. The running of bug is prevented by stalling the currently-running thread until running of other threads solve the violation. In the stalling process of the current thread, if other threads operate the same memory, CFS of the current thread is calculated again and detected again. Running of the thread is resumed if success. During running of the program, recorder variant still needs to be maintained dynamically to record the current access of the memory.

It is noted that not all of FI violations can be solved by stalling. Because learning and training might be not enough, the only appropriate instruction alternating might not appear in the learning and training stage of FI, therefore, it cannot be learned. In order to ensure the program does not have an infinite deadlock, a reasonable threshold value needs to be set according to specific situation of the program. When stalling time reaches a preset time threshold or number of stalling reaches a preset number threshold, running of the thread is resumed and a report about this violation being unsolvable is sent to the developer. After the developer's analysis, if the reason of causing this situation is not the bug, the restriction can be loosened by patching FI and this instruction alternating is allowed to be executed in the future. The patching method is similar to the method for pruning low-appearance-probability program invariants in the pruning module 200.

Preferably, during the actual running of the program, the preventing module 400 and the detection module 300 can be two independent modules. The detection part for violation of the preventing module 400 is substantially the same as the method in the detecting module 300. The difference is that, in order to prevent running of the bug, the step of detecting violation is performed before actual execution of the instruction and no violation report needs to be sent to the developer.

In the exposing module 500, a method for detecting and exposing a multi-thread bug in a normal operation environment is provided. That is to say, a Trigger Set is transferred from the Enforcing Invariants Set, which is used to detect whether Trigger Set violation exists. The Trigger Set is the inversion of the Enforcing Invariants Set.

In the actual operation, it is not realistic to detect those rarely-appearing bugs simply by the above modules of the system. In an embodiment of the present disclosure, according to the definition of FI, if instruction I1 belongs to EIS of instruction I2, it indicates that I1 is executed before I2 in all correctly-running dynamic instances. Otherwise, there might be a hidden bug.

In order to detect potential bugs, implementation steps of the exposing module 500 configured to expose the potential bugs in an embodiment of the present disclosure include:

(1) a Trigger Set (TS(I)) is defined for each of instructions I correspondingly.

In math, TS is the inversion of EIS, i.e., I1 belongs to TS of I2 if and only if I2 belongs to EIS of I1.

(2) EIS is read from the invariants database and is initialized.

(3) After dynamically calculating CSF(I) of each instruction I, whether a condition meets the following formula is determined: TS(I)⊂EIS(I).

If TS(I)/⊂EIS(I), then the current thread is stalled. This rule will be continuously checked until conditions are meet or reach corresponding threshold (this threshold should be set longer than that in step S105).

Because TS is a reflection of EIS, a preset execution order of instructions inherent in EIS will cause violation on TS in the correct instruction alternating. Therefore, the current thread is stalled by an preventing unit to increase flipping probability of running order of two instructions. But, if the order is guaranteed by semaphore or something else, the violation will be maintained until it reaches the threshold.

Preferably, in practice, in an embodiment of the present disclosure, the detection system for concurrency bugs can be achieved by using an instruction monitoring tool PIN of Intel Corporation.

The detecting system for concurrency bugs can automatically detect and prevent potential concurrency bugs in program. No developer's manual annotation is needed and this method can be widely used.

Reference throughout this specification to “an embodiment”, “some embodiments”, “one embodiment”, “an example”, “a specific examples”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific examples”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications may be made in the embodiments without departing from spirit and principles of the disclosure. Such changes, alternatives, and modifications all fall into the scope of the claims and their equivalents.

What is claimed is:

1. A detecting method for concurrency bugs, comprising following steps:
defining a Current Fetter Set for a dynamic instance of a static instruction in program invariants, wherein the program invariants are instruction sets which are executed according to a preset order in a program;
extracting a Belonging Invariants Set and an Enforcing Invariants Set from the Current Fetter Set;
pruning the Belonging Invariants Set and the Enforcing Invariants Set to obtain final results after pruning and storing the final results after pruning in an invariants database;
detecting invariant violation using a detection unit whether a first Current Fetter Set dissatisfying with corresponding Belonging Invariants Set and Enforcing Invariants Set is shown, if yes, determining that the first Current Fetter Set contains a bug, the detection unit generating a violation report; and
stalling a currently-running thread to prevent running of the bug.

2. The method of claim 1, wherein the Current Fetter Set is that: in instructions executed before the instruction, a set of instructions which are executed immediately before the instruction and operate the same memory as the instruction operates.

3. The method of claim 1, wherein the Belonging Invariants Set is a union of the Current Fetter Sets of all dynamic instances of the instruction; the Enforcing Invariants Set is an intersection of the Current Fetter Sets of all dynamic instances of the instruction.

4. The method of claim 1, wherein in the steps of stalling a currently-running thread to prevent running of the bug, when a stalling time reaches a preset time threshold or number of the stalling reaches a preset number threshold, resuming running of the thread.

5. The method of claim 1, further comprising:
transferring a Trigger Set from the Enforcing Invariants Set, which is used to detect whether Trigger Set violation exists, wherein the Trigger Set is the inversion of the Enforcing Invariants Set.

6. A detecting system for concurrency bugs, comprising:
an extracting module configured to extract a Belonging Invariants Set and an Enforcing Invariants Set from a Current Fetter Set and to continuously update the Belonging Invariants Set and the Enforcing Invariants Set;
a pruning module configured to remove low-confidence parts in the Belonging Invariants Set and the Enforcing Invariants Set to obtain final results after pruning;
a detecting module configured to detect invariant violation using a detection unit whether a first Current Fetter Set dissatisfying with corresponding Belonging Invariants Set and Enforcing Invariants Set is shown, if yes, to determine that the first Current Fetter Set contains a bug, the detection unit generating a violation report; and
a preventing module configured to stall a currently-running thread to prevent running of the bug;
an exposing module configured to expose hidden bugs in a multi-thread running instruction.

7. The system of claim 6, wherein the Current Fetter Set is that: in instructions executed before the instruction, a set of instructions which are executed immediately before the instruction and operate the same memory as the instruction operates.

8. The system of claim 6, wherein the Belonging Invariants Set from the Current Fetter Set is a union of the Current Fetter Sets of all dynamic instances of the instruction; the Enforcing Invariants Set from the Current Fetter Set is an intersection of the Current Fetter Sets of all dynamic instances of the instruction.

9. The system of claim 6, wherein the preventing module is further configured to, when a stalling time reaches a preset time threshold or number of stalling reaches a preset number threshold, resume running of the thread.

10. The system of claim 6, wherein the exposing module is further configured to transfer a Trigger Set from the Enforcing Invariants Set, which is used to detect whether Trigger Set violation exists, and the Trigger Set is the inversion of the Enforcing Invariants Set.
